(19) United States
(12) Patent Application Publication
(10) Pub. No.: US 2015/0315773 A1
(43) Pub. Date: Nov. 5, 2015

(54) PLUMBING DRAINAGE COUPLING MEMBER AND ASSOCIATED METHOD

(71) Applicant: LIFTING POINT PTY LTD, Penrith, NSW (AU)

(72) Inventor: Nicholas Bruce MULLANEY, Marulan, NSW (AU)

(21) Appl. No.: 14/650,795

(22) PCT Filed: Dec. 20, 2013
(86) PCT No.: PCT/AU2013/001496

§ 371 Date: Jun. 9, 2015

(30) Foreign Application Priority Data
Dec. 21, 2012 (AU) 2012905612

(51) Int. Cl. E03C 1/122; B29C 67/00; G05B 19/4097

(52) U.S. Cl. CPC E03C 1/122; G05B 19/4097; B29C 67/0088

(57) ABSTRACT

The plumbing drainage coupling member has a manifold from which three fixture connecting portions and extend. Each of the fixture connection portions has a respective inlet connectable directly, or by pipe, to an outlet of a fixture, such as washing tub, sink, bath or shower tray. The manifold has outlet connectable to a drainage pipe. A computerized method of producing the coupling member includes the steps of entering plumbing requirements into a computer so as to design the plumbing drainage coupling member; and using an output from the computer to drive a production method so as to produce the coupling member.

### FIELD OF THE INVENTION

The invention relates to a Plumbing Drainage Coupling Member

### BACKGROUND OF INVENTION

A problem with existing methods of plumbing drainage using coupling members is that they are generally assembled and plumbed by a qualified plumber as a building being built. Also, the existing methods of plumbing drainage using coupling members are not suitable or easily adapted to be used with temporary accommodation.

It is common for the majority of building components to be manufactured off site and then transported and preassembled at a desired location.

In the development of transportable height adjustable temporary accommodation, using standard shipping containers, the overall height of the compacted container can be a major issue. The floor frame and chassis could take up 20% of the compacted unit height. The height of the chassis is largely determined by the depth required to install the plumbing drainage waste system. Normally the plumbing drainage waste system would be installed through the floor supports, the strength of which is reduced due to the penetrations required through the floor support for the large diameter penetrations to install the drainage pipes. This in turn requires the floor supports to be increased to make up for the lost strength. So the thickness of the sub floor area is largely determined by these factors. As an example a currently available floor waste area would be approximately 200 mm and then an allowance for the fall of the pipes would also be required. Therefore a 250 mm area of available height would be required.

A standard shipping container has floor supports of less than 100 mm and it would be an advantage to use the currently available materials already in use. Generally the accommodation units are placed above the ground so there is adequate space available. Installing the pipes afterwards leads to further problems and is required to be installed by qualified persons who have the ability to certify the adequacy and compliance. Also the space below the floor can be restricted, which can make it difficult to conduct installation and inspection of the plumbing drainage waste system.

Onsite installation time, and the associated costs, are important considerations in relation to pre-built accommodation. As a result the drainage pipes would normally be installed inside the floor support area and then protected by a shield to eliminate damage during transport and then be installed and the final services connection would be then connected.

One option that may assist to reduce on-site installation time and costs would be to pre-assemble the required plumbing drainage waste system from parts and length's of pipe at the factory at which the temporary accommodation is manufactured. The pre-assembled plumbing drainage waste system could then be sent to site to be installed, inspected and certified, however a qualified person would be still required. A further drawback is that the pipe assembly would be difficult to produce accurately and would be time consuming.

It is known that single drainage parts such as bends and T's may be certified and their design approved when they leave the factory.

A desired solution is to have preassembled plumbing drainage coupling members made as one piece and for them to have certification attached and be designed and constructed so as to suit pre-specified requirements.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in Australia or in any other country.

### DEFINITIONS

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### OBJECT OF THE INVENTION

It is an object of the invention to provide a plumbing drainage coupling member that ameliorates some of the disadvantages and limitations of the known art or at least provides the public with a useful choice.

### SUMMARY OF INVENTION

In a first aspect the invention resides in a unitary plumbing drainage coupling member manufactured as a single piece, the plumbing drainage coupling member includes:
(i) a manifold having an interior space, a plurality of openings to allow waste water to enter the interior space and a drain outlet to allow waste water to be drained from the interior space; and
(ii) a plurality of fixture connecting portions that connect the manifold to fixtures from which waste water is obtained, each fixture connecting portion has an end connected to a respective opening in the manifold and has the other end connectable to a fixture from which waste water is obtained,
   wherein the plumbing drainage coupling member is adapted to allow for waste water to be drained from the fixtures via the fixture connecting portions into the interior space of the manifold and out through manifold outlet and further wherein the plumbing drainage coupling member is dimensioned and sized such that the plumbing drainage coupling member is adapted to be situated and mounted within any space under the floor.

Preferably, at least one of the fixture connecting portions has an S-bend shape and is connectable to the outlet of a basin, bath or shower tray.

Preferably, the unitary plumbing drainage coupling member is adapted to allow for arc shaped pipes to be connected thereto.

Preferably, the unitary plumbing drainage coupling member is certified at time of manufacture.

Preferably, the space has a height of less than 200 mm and more preferably the space has a height of between 50 mm and 150 mm.

In a second aspect the invention resides in a plumbing drainage coupling member including:
(i) a manifold having an interior space and a plurality of openings to allow waste water to enter the interior space and a drain outlet to allow waste water to be drained from the interior space; and
(ii) a plurality of fixture connecting portions that connect, either directly or by pipe, the manifold to fixtures from which waste water is obtained, each fixture connecting portion having an end connected to a respective opening in the manifold and having another end connectable, either directly or by pipe, to a fixture from which waste water is obtained,
   wherein the plumbing drainage coupling member is adapted to allow for waste water to be drained from the fixtures via the fixture connecting portions into the interior space of the manifold and out through the drain outlet and further wherein the plumbing drainage coupling member includes a flange that allows for fixing of the plumbing drainage coupling member to a planar horizontal surface so as to ensure that a predetermined fall is maintained.

Preferably an upper surface of the plumbing drainage coupling member is shaped in the form of a bathroom floor.

Preferably the upper surface of the plumbing drainage coupling member includes a tray defining a shower area.

In a third aspect the invention resides in a method of producing a plumbing drainage coupling member including the steps of:
entering plumbing requirements into a computer so as to design the plumbing drainage coupling member; and
using an output from the computer to drive a production method so as to produce the plumbing drainage coupling member.

Preferably, the plumbing requirements include spatial data associated with at least one connector for connection of the plumbing drainage coupling member to at least one fixture from which waste water may flow into the plumbing drainage coupling member. In one embodiment the method includes entry of spatial data associated with a proposed positioning of a plumbing fixture having an outlet, whereby the computer is responsive to the spatial data associated with the plumbing fixture so as to calculate spatial data associated with a drain outlet of the fixture.

Preferably the plumbing requirements include spatial data associated with a drain outlet from the plumbing drainage coupling member.

In one embodiment the spatial data is obtained by measurement using any one of: a rule; a tape measure; or blueprints or a laser measuring device. The spatial data may also be obtained by a photographic survey or the scanning of plans or blueprints. In another embodiment the spatial data is a digital three dimensional model obtained with the use of a three dimensional scanner.

Preferably entry of the plumbing requirements includes a user input specifying one or more of the following to form a part of the plumbing drainage coupling member:
a fitting; an inlet; a connector; a tube; a pipe; a valve; a reservoir; an elbow; a tee; a coupling; an outlet; an air vent; a reducer; a junction; a trap; an eyelet; a bung; a flange; or a union.

Preferably the plumbing requirements include dimensional constraints applicable to the plumbing drainage coupling member.

Preferably the plumbing requirements include a zone or country for which the plumbing drainage coupling member is to be certified.

In one embodiment a database of compliance data is accessible by the computer and the computer is responsive to the entered zone or country so as to access compliance data relevant to said zone or country. This embodiment may include the step of using the computer to process the design and the compliance data so as to determine if the design is certifiable for the entered zone or country. Preferably, if it is determined that a design is uncertifiable for an entered zone or country, the computer provides an indication of a portion of the design that renders the design uncertifiable. Also preferably, if it has been determined that a design is uncertifiable for an entered zone or country, the computer provides an indication of a compliance rule that the design contravenes.

Preferably the method includes the step of using the computer to determine fluid flow properties of the design.

In one embodiment the production method includes the use of a three dimensional printer driven by said output so as to print the plumbing drainage coupling member.

In another embodiment the production method includes the use of a milling or routing machine driven by said output so as to produce a mould pattern corresponding to at least part of the plumbing drainage coupling member. This embodiment of the production method includes the use of a vacuum forming machine so as to draw a sheet of plastics material into the mould pattern.

In another aspect the invention resides in a plumbing drainage coupling member produced in accordance with a method as described above.

In yet another aspect the invention resides in a non-transitory computer-readable medium containing computer executable code for instructing a computer to perform the method as described above.

In a further aspect the invention resides in at least one downloadable or remotely executable file containing computer executable code for instructing a computer to perform a method as described above.

In a final aspect the invention resides in a computing apparatus having a central processing unit, associated memory and storage devices, and input and output devices, said apparatus being configured to perform a method as described above.

### BRIEF DESCRIPTION

The invention will now be described, by way of example only, by reference to the accompanying drawings:

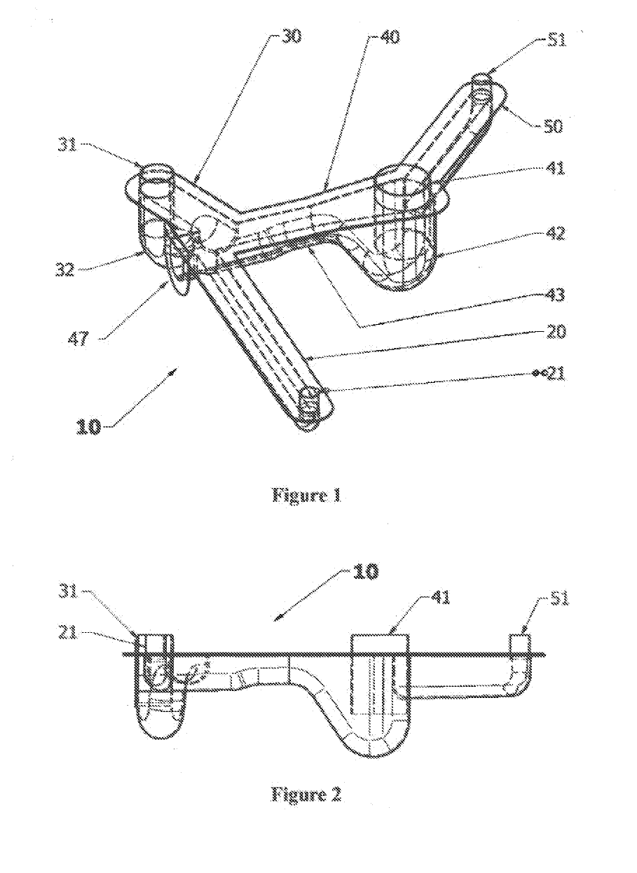

FIG. 1 is a pictorial view of a plumbing drainage coupling member in accordance with a first preferred embodiment of the invention.

FIG. 2 is a side view of the plumbing drainage coupling member as shown in FIG. 1.

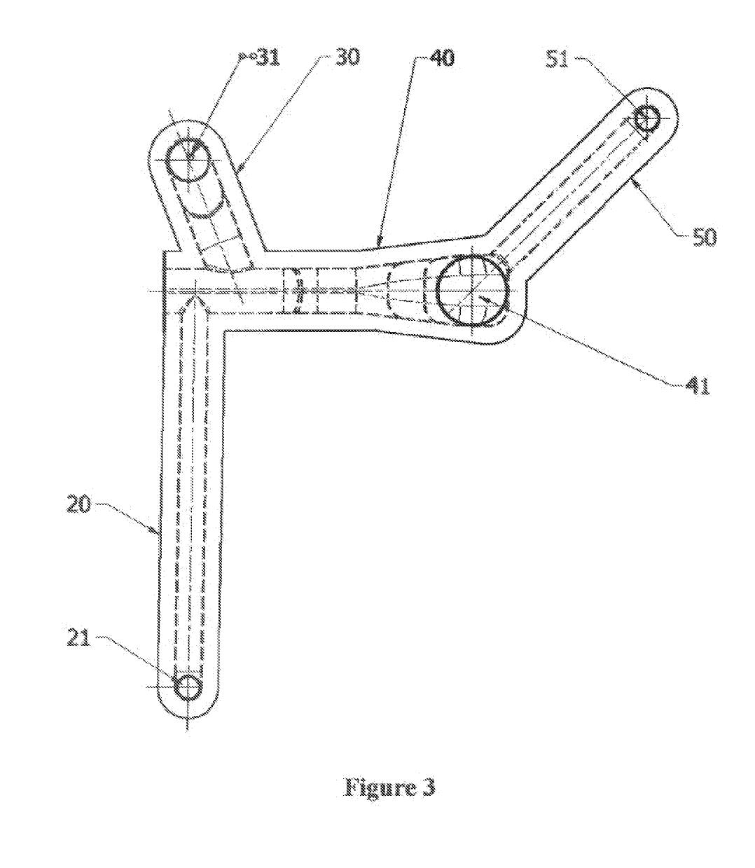

FIG. 3 is a top view of the plumbing drainage coupling member as shown in FIG. 1.

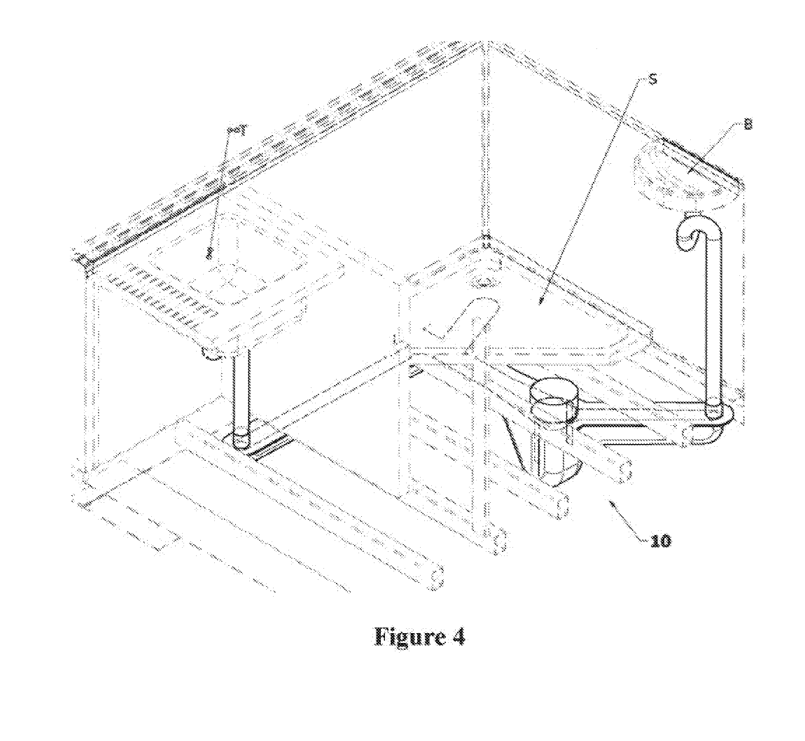

FIG. 4 is a pictorial view of the plumbing drainage coupling member as shown in FIG. 1 assembled and connected to drainage fixtures.

FIG. 5 is a side view of the plumbing drainage coupling member as shown in FIG. 4.

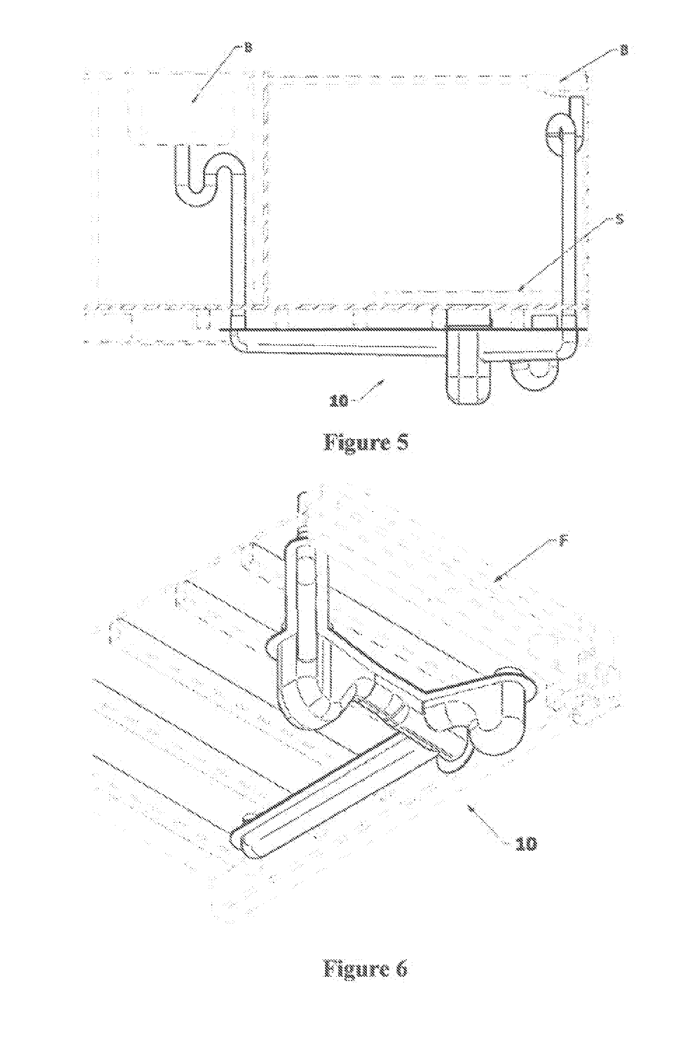

FIG. 6 is an underneath pictorial view of the plumbing drainage coupling member as shown in FIG. 4.

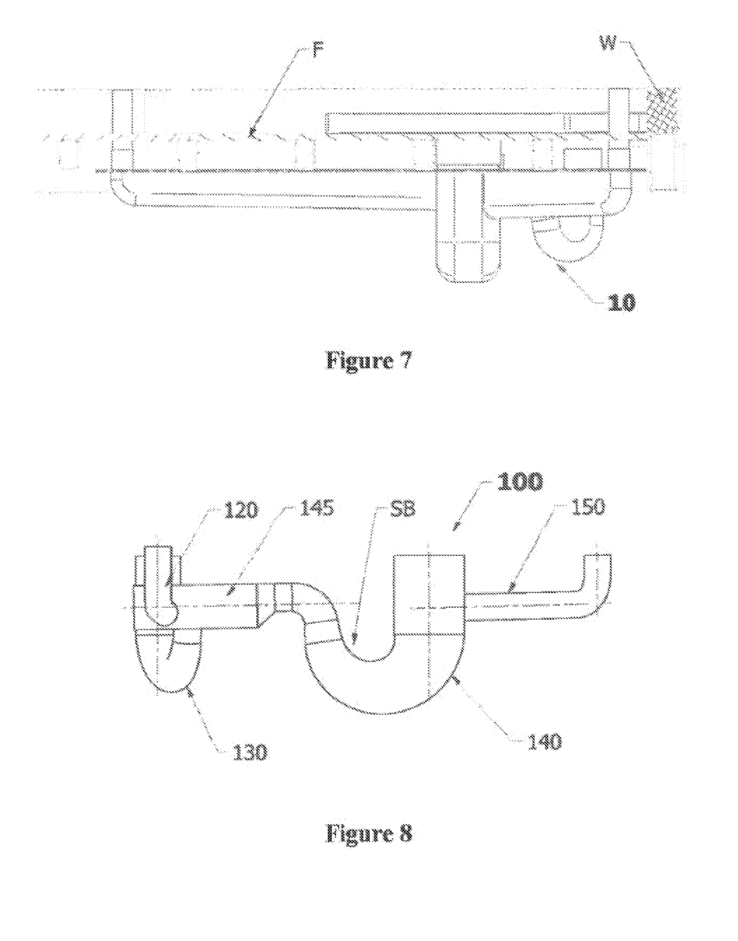

FIG. 7 is a further side view of the plumbing drainage coupling member as shown in FIG. 4.

FIG. 8 is a side view of plumbing drainage coupling member in accordance with a second preferred embodiment of the invention.

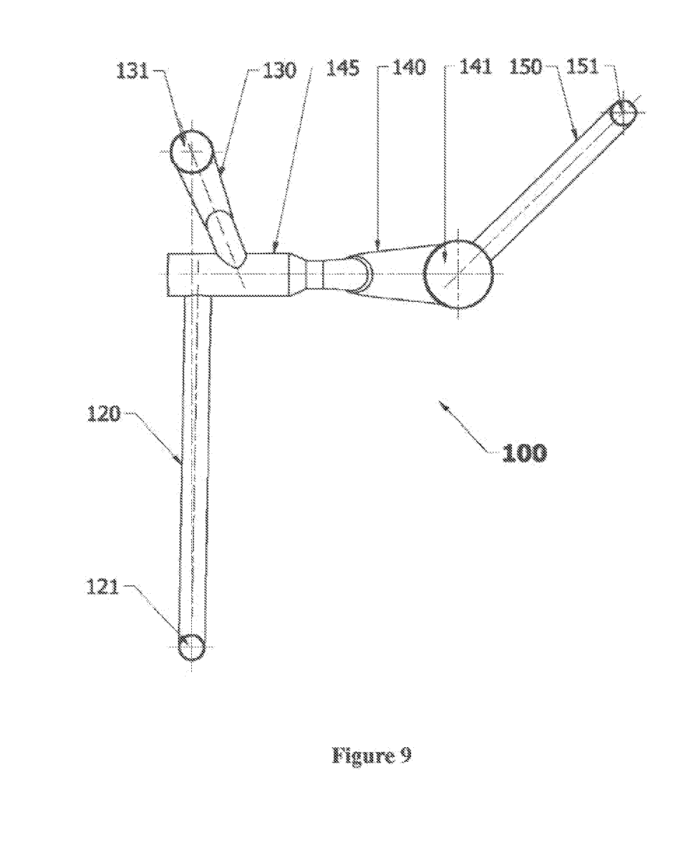

FIG. 9 is a top view of the plumbing drainage coupling member as shown in FIG. 8.

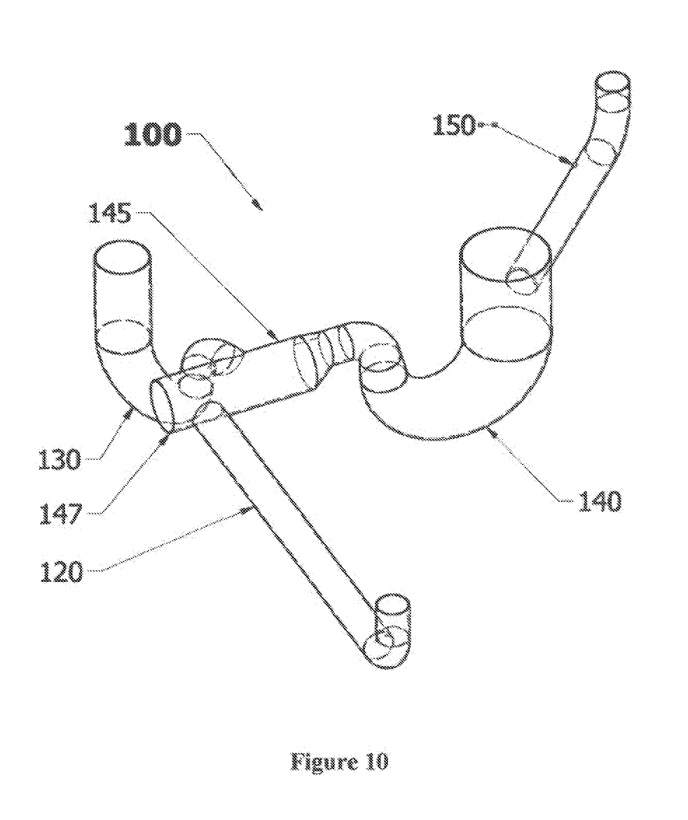

FIG. 10 is a pictorial view of the plumbing drainage coupling member as shown in FIG. 8.

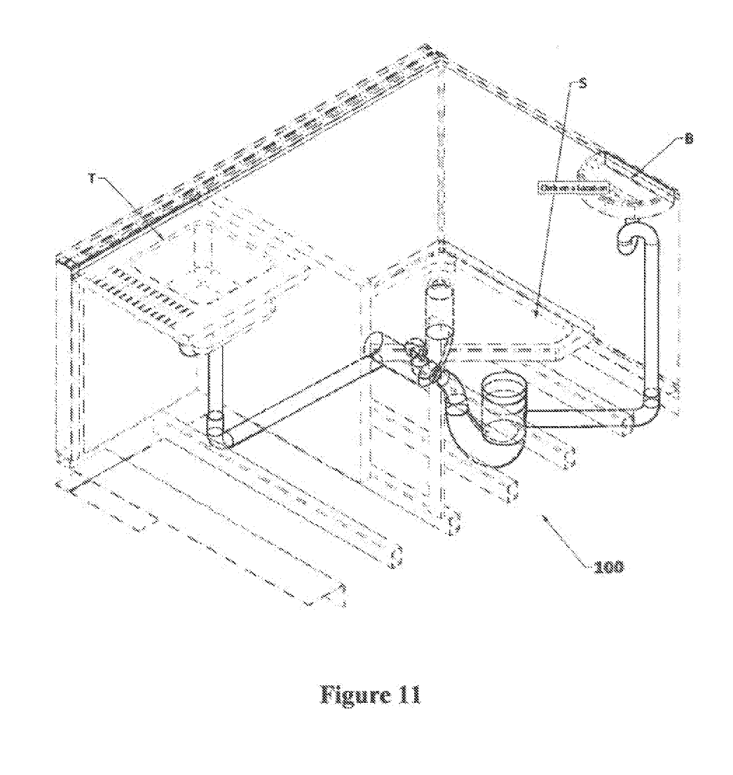

FIG. 11 is a pictorial view of the plumbing drainage coupling member as shown in FIG. 8 assembled and connected to drainage fixtures.

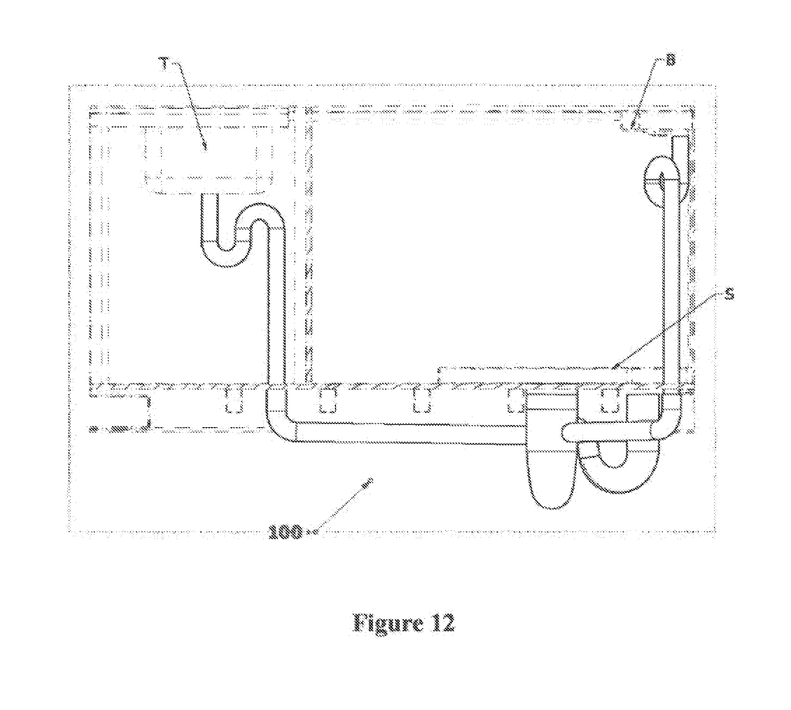

FIG. 12 is a side view of the plumbing drainage coupling member as shown in FIG. 11.

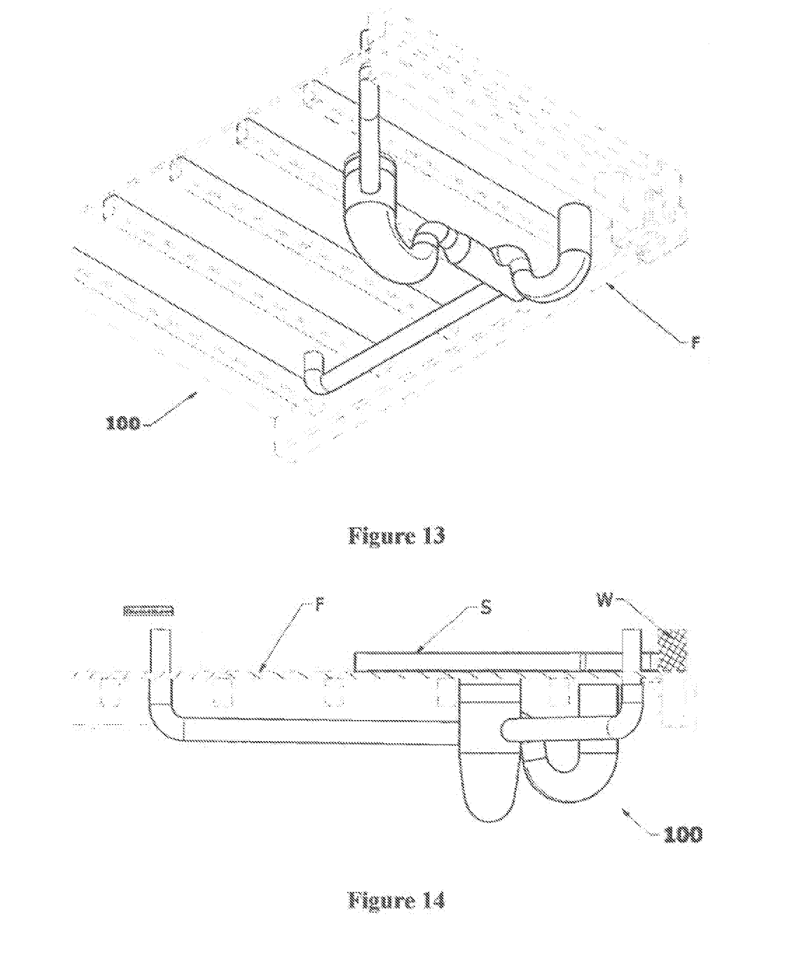

FIG. 13 is an underneath pictorial view of the plumbing drainage coupling member as shown in FIG. 11.

FIG. 14 is a further side view of the plumbing drainage coupling member as shown in FIG. 11.

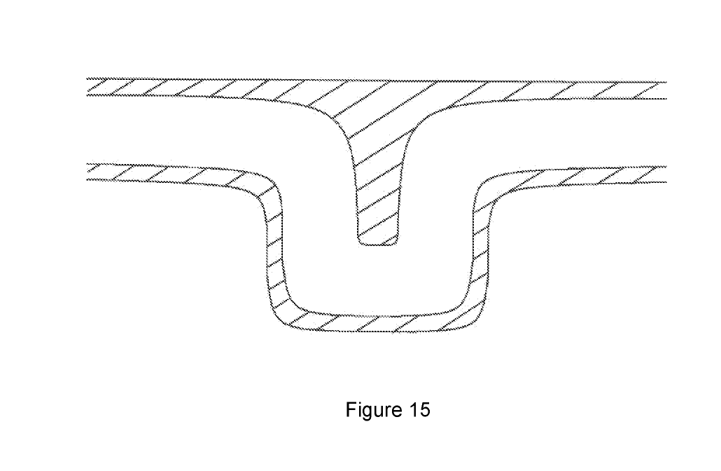

FIG. 15 is a cross sectional view of a trap produced in accordance with an embodiment of the invention.

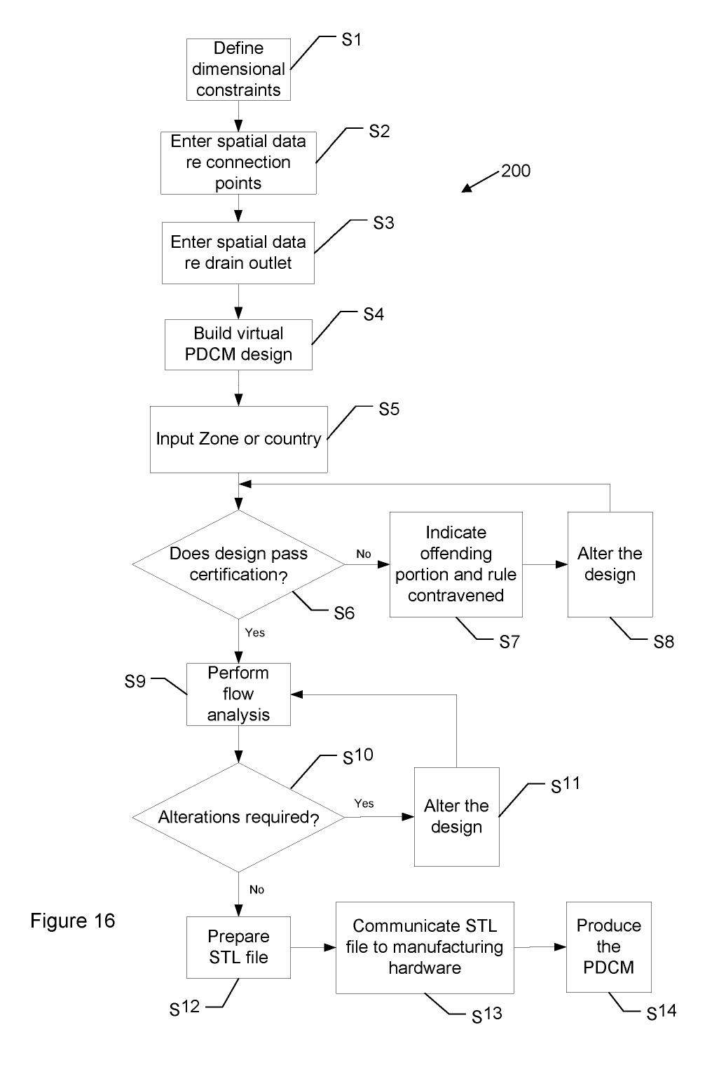

FIG. 16 is a flow chart illustrating steps in a preferred embodiment of the method of designing and producing a plumbing drainage coupling member.

### DESCRIPTION OF THE PREFERRED EMBODIMENT(S)

The following description will describe the invention in relation to preferred embodiments of the invention, namely a plumbing drainage coupling member. The invention is in no way limited to these preferred embodiments as they are purely to exemplify the invention only and possible variations and modifications would be readily apparent without departing from the scope of the invention.

FIGS. 1 to 3 show a plumbing drainage coupling member 10 having a manifold 40 to which three fixture connecting portions 20, 30 and 42 depend outwardly there from. A further fixture connecting portion 50 is connectable to fixture connection portion 42. Each of the fixture connection portions 20, 30, 42 & 50 has a respective inlet 21, 31, 41 & 51 connectable directly, or by pipe, to an outlet of a fixture from which waste water is to be drained, such as washing tub, sink, bath or shower tray. The manifold has outlet 47 connectable to a drainage pipe to allow waste water collected in the interior of the manifold to be drained there from.

FIGS. 4 to 7 show the plumbing drainage coupling member 10 mounted and affixed to the underneath of a floor F. The fixture connection portions 20, 30 & 50 are shown connected to a tub T, basin B and shower tray T. As can be seen for example in FIG. 12, in some instances the space under the floor in which the plumbing drainage coupling member 10 is mounted may be limited. For example, in some embodiments the plumbing drainage coupling member 10 is shaped to fit within an under floor space having a height of less than 200 mm. More preferably, the space may have a height of between 50 mm and 150 mm.

The plumbing drainage coupling member 10 has a continuous flange that allows for fixing if required at available points and also ensures that the required fall is maintained and thus eliminates the time consuming/costly installation of brackets. For example, in some circumstances it may be a requirement to ensure that the water supporting surfaces of the plumbing drainage coupling member maintain a minimum fall of, say, 1 in 60. If so, the continuous flange is provided at an angle of approximately 1° relative to the water supporting surfaces in which the minimum fall is required. In this way, when the continuous flange is installed such that it is horizontal, the water supporting surfaces of the plumbing drainage coupling member maintain a minimum fall. As will be appreciated by those skilled in the art, the fall of the plumbing drainage coupling member must be such that, in use, water within the manifold 40 is directed towards the outlet 47.

FIGS. 8 to 14 show a further embodiment of plumbing drainage coupling member 100. The main difference to that shown in FIGS. 1 to 7 is that the plumbing drainage coupling member 100 does not have the continuous flange. As can be seen, for example, in FIG. 8, one of the fixture connecting portions labelled SB has an S-bend shape and is connectable via pipe 150 to the outlet of a basin, bath or shower tray.

The plumbing drainage coupling member 100 has a manifold 145 from which three fixture connecting portions 120, 130 and 140 depend outwardly. A further fixture connecting portion 150 is connectable to fixture connection portion 140. Each fixture connection portion 120, 130, 140 & 150 has a respective inlet 121, 131, 141 & 151 connectable directly, or by pipe, to an outlet of a fixture from which waste water is to be drained, such as washing tub, sink, bath or shower tray. The manifold has outlet 147 connectable to a drainage pipe to allow waste water collected in the interior of the manifold to be drained there from.

FIGS. 11 to 14 show the plumbing drainage coupling member 100 mounted and affixed to the underneath of a floor F. The fixture connection portions 120, 130 & 150 are shown connected a tub T, basin B and shower tray T.

The plumbing drainage coupling member can be designed and certified to comply with many world regulation zones and have approval stamps placed on the plumbing drainage coupling member and as such be easily recognised as an approved item that meets the required standards. In other circumstances a particular plumbing drainage coupling member could be shipped together with the accommodation unit that is suitable for the intended country or region.

To cater for tolerances some pipes or junctions could be adjustable to reduce or increase length and slide into each other. For the installation push in fittings are envisaged where the push in fittings can be used with known fastening systems to hold the plumbing drainage coupling member and fittings in place and can be unfastened in the case of the accommodation unit being required to be relocated.

With the introduction of new manufacturing systems such as 3D printing and others it is possible to create intricate shapes and products that were not possible with previous manufacturing processes such as injection moulding and extruding. 3D printing is envisaged as a preferred and suitable method of manufacturing the plumbing drainage coupling members. There are of course other methods that can replicate the desired plumbing drainage coupling members such as vacuum and blow moulding, casting, fabrication and software driven manufacturing systems.

The travel of waste water does not require plumbing components such as pipes to be restricted to having a round shape. As such, the present invention allows plumbing components such as pipes to be specifically designed and shaped so as to include lips for fastening to the underside of floor supports. Such shapes would assist in the speed of installation compared to existing methods of installation and have the potential to use less material and be more space efficient. If the production method to be used is printing of the plumbing drainage coupling member on a 3D printer, then the design of the plumbing drainage coupling member may favour shapes that are generally suitable for 3D printing.

The design freedom provided by the present invention allows the user to design plumbing fittings that are optimised for the available space. For example, rather than forming a trap, for example, from circular piping, the user may design a trap having a cross section such as that illustrated in FIG. 15, for example. The invention also provides the user with design freedom to add an air vent, if desired, along the top of the pipe to provide a path along which gasses may travel to help avoid gurgling and to promote the free flow of fluid such as waste water. The user would also have the freedom to experiment with variously shaped pipes, such as diamond shaped pipes, which would be likely to have desirable strength and gas return properties. Another possible pipe shape would feature a round bottom with a half diamond top.

For embodiments that are proposed to be used in a bathroom context, the plumbing drainage coupling member may feature an upper surface that is shaped in the form of a complete bathroom floor. In this embodiment the upper surface includes formations for connection of pipes leading to outlets from fixtures such as basins, toilets, baths, etc. Additionally, a portion of the upper surface of this embodiment is shaped as a tray having a waste water outlet to define a shower flooring area. The upper surface of such an embodiment is formed from a single sheet of water proof material, such as a plastics material; thereby ensuring that the floor of the bathroom in which it is installed is waterproof. It will be appreciated by those skilled in the art that the upper surface that is shaped as a complete bathroom floor must be engineered with sufficient strength properties so as to withstand typical bathroom floor loadings with a suitable safety factor. Internal ribbing, gusseting and/or supports may be utilised to provide the bathroom floor with the required strength properties. This embodiment has the potential to significantly reduce the amount of time required to construct and/or assemble a bathroom.

With the view of mass production of accommodation units this method of a single piece of plumbing drainage coupling member is advantageous as it will:
Provide a pre certified drainage system eliminating the requirement of qualified inspection and reducing cost.
Speed up installation and reduce cost.
Eliminate the requirement of the drainage in the floor support zone.
Allow for smaller floor supports reducing cost and height of the floor supports and reduce cost.
Allow for an improved quality control and end product.
Allow replication of large amounts of identical items and remove the costly system of gluing parts together as done currently.
Be inspected and replaced easily.
Be certified for many countries when products have a global market.
Allow for close tolerance.
Be removed if required.
Be installed prior to the container being placed in position and no requirement to go under the container.
Reduce and eliminate joints that can be the cause of future problems due to incorrect installation that is difficult to monitor during assembly by unskilled workers.
Allow, when associated with a computer program, for a plumber to produce their own products with an approved kit that may include a glazing product, the required seals, and the appropriate material that the item is to be printed or produced with.
Allow for the creation of any angle that is required for the most direct route to the next required position and are not restricted to 15 degrees, 45 degrees etc. This allows the user to design the manifold around obstructions and making use of existing support structures.
Allow the designer to alter the thickness or structural integrity of portions of the design to account for support. That is, if there is an abundance of support points, then the coupling member may be designed this less wall thickness and/or less ribbing or other structural support. For applications in which less support points are available, the design may have thicker side walls and more ribs for support.
Allow the designer to design more space efficient plumbing components, such as a trap that is not limited to being composed of circular pipes.
Allow for arc shaped pipes as opposed to straight pipes.
Allow to be Certified when it leaves the factory.
Allow a glazing solution to be applied so as to allow a smooth surface and thus contribute to improved flow through the plumbing drainage coupling member if required.
Allow the plumbing drainage coupling member to be used in situations where there are large numbers of the same design also including high rise buildings, project homes and in some circumstances used by small plumbing contractors where the plumber's requirements can be entered into a computer program and then required zone or country of certification entered and then 3D printer or other software driven production method be used and eliminating the requirement of delays in ordering, assembly and delivery times.
Allow in an under slab installation identifying points to be marked on the plumbing drainage coupling member such as dots where these dots can indicate offset points from formwork or other stationary points on a building site such that the plumbing drainage coupling member can be located in the correct position.
When installation of the member is under a floor a continuous flange can be incorporated into the design allowing for fixing if required at available points and also ensure that the required fall is maintained and thus eliminating, or at least ameliorating, the time consuming/costly installation of brackets.

With reference to FIG. 16, the method 200 of producing the plumbing drainage coupling member 10 (hereinafter PDCM for short) may be implemented upon a computing platform, such as a personal computer. The preferred embodiment utilizes a computing apparatus configured to perform the required processing. This computing apparatus has a central processing unit (CPU); associated memory, for example RAM and ROM; storage devices such as hard drives, writable CD ROMS and flash memory; input devices such as a keyboard and mouse; output devices, for example a printer; a display in the form of a screen and a communications link in the form of a modem.

It will be appreciated that the actual computing platform upon which the invention is implemented will vary depending upon the amount of processing power required. In some embodiments the computing apparatus is a stand alone computer, whilst in other embodiments the computing apparatus is formed from a networked array of interconnected computers. Additionally, the terms “computer”, “computing apparatus” and the like as used in this patent specification, including in the claims, are to be construed in a broad manner so as to include any device capable of the necessary processing, display and input. Non-limiting examples of such devices include mobile phones, personal digital assistants, tablets, information kiosks and the like.

The method 200 may be embodied in computer software in the form of executable code for instructing a computer to perform the inventive method. The software and its associated data are capable of being stored upon a computer-readable medium, for example in the form of one or more compact disks. Alternative embodiments make use of other forms of digital storage media, such as Digital Versatile Discs (DVD's), hard drives, flash memory, Erasable Programmable Read-Only Memory EPROM, and the like. Alternatively the software and its associated data may be stored as one or more downloadable or remotely executable files that are accessible via a computer communications network such as the internet. Mobile phone apps are examples of downloadable files and programs executed in a cloud computing context provide examples of remotely executable files.

The preferred embodiment of the method 200 makes use of the Standard Tessellation Language to create a three dimensional virtual model of the PDCM and the space in which the PDCM is to be installed. This creates an output in the form of an STL file, which defines the surface geometry of the PDCM in a triangulated manner. More particularly, the vertices of each triangle are defined using a three-dimensional Cartesian coordinate system. However, it will be appreciated that other embodiments may make use of various other known computer implementable systems for modelling three dimensional spaces and objects. For example, in an alternative embodiment three dimensional space is modelled by the computer by the establishment of a three dimensional array in the format (x, y, z). The x, y and z components of the array correspond to the width, length and height dimensions of the space (which is effectively divided into cubes of sufficiently small size). The computer stores variable values in the array, which are indicative of the elements that are being modelled as positioned within each of the cubes. For example, if the cube at position, say, (10, 25, 15) is empty, then a ‘0’ value variable may be stored at array position (10, 25, 15).

Various other variable values may be assigned other meanings, such as ‘1’ for a cube representing a boundary condition, ‘2’ for a cube representing a part of the PDCM, and so on.

The computer is programmed so as to display on the screen a two dimensional rendering of the three dimensional spaces and objects that are being modelled. These renderings may be depicted as a perspective projection, an isometric projection, a left side view, a right side view, a plan view, a front view, a rear view or a bottom view. The particular view depicted at any particular point in time depends upon the setting of a user operable view selector.

The first step of the computer-implemented method 200 is to enter plumbing requirements into a suitably programmed computer. This commences at step Si with a definition of the external dimensional constraints applicable to the PDCM, which will typically be associated with the space in which the PDCM is to be used. For example, if the PDCM is to be used under a floor, then spatial data associated with the under floor space is entered into the computer. For example, the length, width and height of the under floor space may be entered by the user into the computer via the keyboard. These dimensions are stored in the computer's memory and the computer processor then defines a virtual three dimensional space that corresponds to the entered spatial data. In the preferred embodiment the computer is programmed so as to automatically limit the user in subsequent steps to designing a PDCM that will fit within that virtual three dimensional space. In a similar manner the user enters data that defines the dimensions of the above-floor space.

The dimensions of the above and below floor spaces may be determined simply by using a measuring tool, such as a rule; a tape measure; or a laser measuring device, to measure the relevant dimensions on the real-world structure that is being modelled. However, such manual measurement may be subject to operator error and may not provide the spatial data to at sufficiently high resolution. These potential issues may be addressed by making use of a known three dimensional scanner unit to create a digital three dimensional model of the above and below floor spaces. This involves placing the three dimensional scanner unit within the real-world structure and allowing it to project multiple laser beams in a plurality of directions so as to measure distances that are correlated with position to form the digital three dimensional model of the above and below floor spaces. This spatial data is then communicated from the dimensional scanner unit to the computer to allow the computer to accurately model the above and below floor spaces. The spatial data may also be obtained by the scanning of plans or blueprints of the under and above-floor spaces.

The next plumbing requirements that are entered at step S2 include spatial data associated with the connection points at which the PDCM is to be connected, either directly or indirectly, to the required fixture outlets from which waste water may flow into the PDCM.

The preferred embodiment includes pre-defined templates for virtual fixtures that are modelled from the surface geometry of known fixtures such as real-world washing tubs, sink, baths, shower trays, etc. If the user intends to design the PDCM for use with the real-world fixtures for which models have already been entered into the computer, then the user simply provides an input to select the appropriate pre-defined virtual fixture, and then provides an input to indicate the proposed positioning of that virtual fixture within the model of the above floor space on the computer. For example, a user may select a virtual sink that models the proposed real-world sink that is to be used with the PDCM that is to be produced. The user then uses their mouse, or other input device, to position that virtual sink at the required position within the displayed rendering of the above-floor virtual space. The dimensions of this position are then stored in the computer's memory. The virtual model of the fixture includes the spatial positioning of the outlet of that fixture. Hence, once the overall proposed positioning of the virtual fixture has been defined, the computer can calculate spatial data associated with the proposed positioning of the outlet of that fixture. This spatial data is stored in the memory of the computer for use in a subsequent step that will be defined in further detail below whereby the computer ensures that the inlets 21, 31, 41 and 51 into the manifold 40 of the PDCM that is being designed are aligned with the proposed positioning of the outlets of the fixtures.

If the user wishes to model a fixture for which a virtual model has not already been prepared, such as a new design for a sink, toilet, etc, it is necessary to input spatial data in relation to that fixture into the computer. A quick and accurate method to do so makes use of the three dimensional scanner unit mentioned previously. This unit uses lasers to scan the fixture and creates a detailed three dimensional virtual model, which is communicated to the computer and stored in the computer's memory. The user then uses the mouse, or other input means, to indicate to the computer where the outlet of the fixture is located on the virtual model and this data is stored in the computer's memory. This virtual model of the new fixture is then available to be used in the steps outlined in the preceding paragraph.

As an alternative to the above-described procedure of the user positioning virtual models of the fixtures within the virtual model of the above-floor space so as to define the proposed positions of the fixture outlets, another option involves using the three dimensional scanner unit to scan a real-world structure in which the real-world fixtures have already been installed in the correct positions. This can enable the spatial data associated with the above-floor space, the below-floor space and the positioning of the fixtures and the fixture outlets to be gathered together and then communicated to the computer for storage in the computer's memory.

Yet another option for capturing spatial data relating to the above-floor and under-floor spaces is to utilise a digital camera to take photographs of the above-floor and under-floor spaces from various vantage points. These photos are downloaded to the computer and processed to provide the necessary spatial data. Accurate modelling of the above-floor and under-floor spaces allows the user to design a PDCM that avoids obstacles or utilises them as fixing and support points.

The next plumbing requirement that is entered at step S3 into the computer is spatial data associated with a drain outlet from which waste water may flow from the plumbing drainage coupling member and into the sewer. For example, in some circumstances it may be a requirement of the PDCM that its waste water be delivered to a sewerage pipe having a predetermined position within the under-floor space. Once again, this information may be gathered manually using measuring tools and then entered into, and stored by, the computer. Alternatively, it may be gathered by the three dimensional scanning unit and then entered into, and stored by, the computer.

At this point the positioning of the inlets into the PDCM have been defined (i.e. so as to align with the positions of the fixture outlets) and the positioning of the outlet from the PDCM has been defined (i.e. the positioning of the drain outlet). Hence, the user is now free to enter further plumbing requirements into the computer at step S4 to create a virtual design for the PDCM.

The preferred embodiment has a library of standard virtual PDCM designs that may provide a useful starting point for the user when commencing a new design. The user simply chooses the standard PDCM design that is closest to their desired design, and uses the computer to alter the standard design to yield the desired design. Alternatively, the user can use the computer to build a new virtual PDCM design from scratch.

To facilitate the creation of the design, the computer presents the user with a graphical user interface that depicts various standard plumbing fittings, such as inlets, connectors, tubes, pipes, valves, reservoirs, elbows, tees, couplings, outlets, air vents, reducers, junctions, traps, eyelets, bungs, flanges and unions. As was the case with the virtual models for the fixtures, the computer has access to predefined templates for virtual models of each of the plumbing fittings. The user navigates a menu system to specify the particular plumbing fitting, including the desired size and other applicable factors, which are required form a part of the PDCM.

If the user wishes to create a virtual model for a new plumbing fitting for which a virtual model is not already available, it is once again possible to use the three dimensional scanner unit to scan the new plumbing fitting so as to gather the necessary spatial data, which is then communicated to the computer for storage in the computer's memory. This spatial data is accessed whenever the user subsequently wishes to use a virtual model of that plumbing fitting in a design for a PDCM.

To create a design for the PDCM illustrated in FIGS. 1 to 3, by way of example, the user may commence by using the mouse or other input means to select a virtual model of a standard inlet 51. The user then uses the mouse or some other input means to indicate to the computer where this virtual inlet is to be positioned within the three dimensional space that the computer is modelling. The user also indicates the proposed orientation of the virtual inlet. If the user wishes to vertically align this inlet with the previously defined positioning of a fixture outlet, the user may provide an input ordering the computer program to implement a ‘snap’ routine, which precisely positions and orients the virtual inlet in vertical alignment with the fixture outlet position. Hence, once the PDCM has been produced, it will be possible to connect the real-life inlet 51 with the real-life fixture outlet via a vertical length of piping. The ‘snap’ routine also allows for other types of alignment, such as horizontal alignment and alignment at a user-defined angle.

Once the positioning of the virtual inlet has been defined, the user may continue to build up the PDCM design by using the mouse or other input means to select a virtual model of an elbow from the list of available virtual models of plumbing fittings. As can be seen in FIG. 2, for example, the elbow attaches to the bottom of the inlet 51. The user positions the elbow adjacent the inlet 51 and the ‘snap’ routine aligns the bottom of the inlet 51 with the top of the elbow.

To continue building up a virtual model for the PDCM that is illustrated in FIGS. 1 to 3, the user would use the mouse or other input means to select a virtual model of a pipe. This virtual pipe is of indefinite length, having ends that can be stretched in response to user inputs to whatever length is required. Hence, the user provides an input to the computer to indicate that one end of the pipe should connect to the elbow and the other end of the pipe should connect to fixture connection portion 42.

It will be appreciated that the user can continue to take steps of the kinds described in the preceding paragraphs to add individual plumbing fittings to the PDCM design until the design for the PDCM is completed.

At step S5 the user has the option of inputting a further plumbing requirement in the form of a zone or country for which the plumbing drainage coupling member is to be certified. For example, the user may be designing a PDCM which is intended to be used in, say, Australia. If so, the user makes an input to select Australia from a list of available zones or countries. A database of compliance data is stored in the computer's memory. This database is compiled with reference to the building code that is applicable within the selected zone or country. For the sake of example, we shall assume that the Australian plumbing building code dictates requirements such as:
the usage of a minimum piping diameter of 50 mm for piping that is intended to carry sink waste;
a minimum trapped water height of 30 mm in water traps;
piping must provide a minimum gradient of 1 in 20 to promote water flow.

At step S6 the computer processor is programmed to access the compliance data associated with the selected zone or country and to process the design and the compliance data so as to determine if the design is certifiable for the entered zone or country. With reference to the first of the exemplary requirements listed above, the computer processor would process the virtual fixtures that have been positioned within the model of the above-floor space to determine if a virtual sink is present. If so, the processor would then identify any virtual piping that is attached to the virtual sink outlet, ascertain the diameter of that virtual piping, and conduct a comparison to check if that diameter is equal to, or exceeds 50 mm. If it is determined that the diameter is less than 50 mm, the process flow proceeds to step S7 whereby the computer drives the display so as to highlight the offending length of piping to provide the user with an indication of the portion of the design that renders the design uncertifiable. In the preferred embodiment, the computer renders the offending piping in a red colour. When the user hovers the mouse over that red portion of piping, the computer provides an indication of a compliance rule that the design contravenes by displaying a message that states “This piping must be of at least 50 mm diameter to comply with building code AU-XXX”.

Similarly, with reference to the second of the exemplary requirements listed above, the computer processor would process the plumbing fittings that together make up the PDCM design to determine if any traps are present. If so, the computer processor would calculate the static water levels that would be present in the PDCM design (assuming it has been installed as intended) to determine if the example requirement of a minimum trapped water height of 30 mm is complied with. If not, the user would receive an indication of the trap that contravenes the requirement and an indication of the particular compliance rule that the design contravenes.

With reference to the third of the exemplary requirements listed above, the computer processor would process the plumbing fittings that together make up the PDCM design to determine if any pipes are present. If so, the computer processor would calculate the gradient of each of the identified lengths of pipe. If any of them have a gradient of less than 1 in 20, the user would receive an indication of the pipe or pipes that contravene the requirement and an indication of the particular compliance rule involved.

If the compliance check reveals that one or more of the requirements have not been met, then at step S8 the user may provide inputs to the computer to alter the design of the PDCM with the aim of securing compliance and then the process flow loops back to the compliance check at step S6. Once the compliance check reveals that the requirements have been met, the process flow proceeds onto step S9.

Step S9 is an optional step that may be taken once the design of the PDCM has been created, whereby the user instructs the computer to determine the fluid flow properties of the design. In response to such a user input, the computer processor makes use of known computational fluid dynamics techniques to model the gas and liquid flow properties of the PDCM design. It will be appreciated by those skilled in the art that the liquid must flow smoothly down the PDCM whilst gases flow smoothly up to avoid any undesirable suction effects, such as gurgling.

At step S10 the user assesses the predicted flow properties and decides if alterations to the PDCM design are required. If so, at step S11 the user may provide inputs to the computer to alter the design of the PDCM with the aim of improving the flow properties, for example by adding an air vent at a position within the PDCM that is remote from the connection to the services. The process flow then loops back to step S9 at which the computer performs a further flow analysis. If the user is content with the predicted flow properties, then the process flow proceeds to step S12.

Some zones or countries may have building code requirements that dictate particular fluid flow or venting requirements. If so, the output of the fluid flow analysis at step 10 may be feed into a further assessment of whether the proposed PDCM design may be certified for such zones or countries.

The design of the PDCM has now been finalised. At step S12 the user instructs the computer processor to prepare an STL file defining that design. At step S13 this file is provided as an output from the computer and used to drive a manufacturing hardware so as to produce the PDCM at step 14. In one embodiment that is particularly suited to PDCM's that are to be produced in relatively limited numbers, this involves the use of a three dimensional printer that is responsive to the STL file so as to print the PDCM. As is known in the art of three dimensional printing, successive layers of material (such as powder, paper, polymer, resin or sheet material) are laid down in a series of cross sections so as to form the desired solid object. The object must be printed from a water impervious material, or at least one that becomes water impervious subsequent to the printing process, so as to be suitable for use as a plumbing drainage coupling member.

In another embodiment the production method includes the use of a computer-driven milling or routing machine that is responsive to the STL file so as to produce a mould pattern corresponding to at least part of the plumbing drainage coupling member. Once the mould has been machined by the milling or routing machine, it is placed into a vacuum forming machine along with a sheet of plastics material. In a manner that is known in the art of moulding, a vacuum is used to draw the sheet of plastics material into the mould pattern and to form it into the desired shape. Typically, this technique would require a division of the PDCM design into an upper portion and a lower portion, for which separate moulds would be made by the computer-driven milling or routing machine. Next one plastics sheet would be formed into the upper portion and another plastics sheet would be separately formed into the lower portion. Finally, the two portions would be joined together, for example by gluing, heat welding or some other suitable method. This moulding-based production method is generally more suited for applications in which a larger number of a particular PDCM design is required.

In some circumstances, a user may choose to design two PDCM's for installation within a single under-floor space, with one PDCM being intended to collect grey water and the other PDCM being intended to collect waste water.

The method of the preferred embodiment advantageously allows for PDCM's to be custom designed and produced in an efficient manner. The resulting PDCM's are able to be produced at a factory and packaged as a part of a modular housing product. Once the modular housing product is in situ, the preferred embodiment of the PDCM is easier and quicker to install as compared to the prior art requirement to employ a plumber on site to create a PDCM by the joining of separate plumbing fittings.

### Variations

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

1. A method of producing a plumbing drainage coupling member including the steps of:
entering plumbing requirements into a computer so as to design the plumbing drainage coupling member; and
using an output from the computer to drive a production method so as to produce the plumbing drainage coupling member.

2. A method according to claim 1 wherein the plumbing requirements include spatial data associated with at least one connector for connection of the plumbing drainage coupling member to at least one fixture from which waste water may flow into the plumbing drainage coupling member.

3. A method according to claim 2 including entry of spatial data associated with a proposed positioning of a plumbing fixture having an outlet, whereby the computer is responsive to the spatial data associated with the plumbing fixture so as to calculate spatial data associated with a drain outlet of the fixture.

4. A method according to claim 1 wherein the plumbing requirements include spatial data associated with a drain outlet from the plumbing drainage coupling member.

5. (canceled)

6. A method according to claim 2 wherein the spatial data is a digital three dimensional model obtained with the use of a three dimensional scanner.

7. A method according to claim 1 wherein entry of the plumbing requirements includes a user input specifying one or more of the following to form a part of the plumbing drainage coupling member:
a fitting; an inlet, a connector; a tube; a pipe; a valve; a reservoir; an elbow; a tee; a coupling; an outlet; an air vent; a reducer; a junction; a trap; an eyelet; a bung; a flange; or a union.

8. A method according to claim 1 wherein the plumbing requirements include dimensional constraints applicable to the plumbing drainage coupling member.

9. A method according to claim 1 wherein the plumbing requirements include a zone or country for which the plumbing drainage coupling member is to be certified.

10. A method according to claim 9 wherein a database of compliance data is accessible by the computer and wherein the computer is responsive to the entered zone or country so as to access compliance data relevant to said zone or country.

11. A method according to claim 10 including the step of using the computer to process the design and the compliance data so as to determine if the design is certifiable for the entered zone or country.

12. A method according to claim 11 wherein, if it is determined that a design is uncertifiable for an entered zone or country, the computer provides an indication of a portion of the design that renders the design uncertifiable.

13. A method according to claim 11 wherein, if it has been determined that a design is uncertifiable for an entered zone or country, the computer provides an indication of a compliance rule that the design contravenes.

14. A method according to claim 1 including the step of using the computer to determine fluid flow properties of the design.

15. A method according to claim 1 wherein the production method includes the use of a three dimensional printer driven by said output so as to print the plumbing drainage coupling member.

16. A method according to claim 1 wherein the production method includes the use of a milling or routing machine driven by said output so as to produce a mould pattern corresponding to at least part of the plumbing drainage coupling member.

17. (canceled)

18. A plumbing drainage coupling member produced in accordance with a method as defined in claim 1.

19. A plumbing drainage coupling member including:
a manifold having an interior space and a plurality of openings to allow waste water to enter the interior space and a drain outlet to allow waste water to be drained from the interior space; and
a plurality of fixture connecting portions that connect, either directly or by pipe, the manifold to fixtures from which waste water is obtained, each fixture connecting portion having an end connected to a respective opening in the manifold and having another end connectable, either directly or by pipe, to a fixture from which waste water is obtained,
wherein the plumbing drainage coupling member is adapted to allow for waste water to be drained from the fixtures via the fixture connecting portions into the interior space of the manifold and out through the drain outlet and further wherein the plumbing drainage coupling member includes a flange that allows for fixing of the plumbing drainage coupling member to a planar horizontal surface so as to ensure that a predetermined fall is maintained.

20. A plumbing drainage coupling member according to claim 19 wherein an upper surface of the plumbing drainage coupling member is shaped in the form of a bathroom floor.

21. A plumbing drainage coupling member according to claim 19 wherein the upper surface of the plumbing drainage coupling member includes a tray defining a shower area.

22. A unitary plumbing drainage coupling member manufactured as a single piece, the plumbing drainage coupling member includes:
a manifold having an interior space, a plurality of openings to allow waste water to enter the interior space and a drain outlet to allow waste water to be drained from the interior space; and
a plurality of fixture connecting portions that connect the manifold to fixtures from which waste water is obtained, each fixture connecting portion has an end connected to a respective opening in the manifold and has the other end connectable to a fixture from which waste water is obtained,
wherein the plumbing drainage coupling member is adapted to allow for waste water to be drained from the fixtures via the fixture connecting portions into the interior space of the manifold and out through manifold outlet and further wherein the plumbing drainage coupling member is dimensioned and sized such that the plumbing drainage coupling member is adapted to be situated and mounted within any space under a floor.

23.-30. (canceled)
